(19) United States
(12) Patent Application Publication
(10) Pub. No.: US 2004/0067182 A1
(43) Pub. Date: Apr. 8, 2004

(54) Gas-release packet

(76) Inventors: Robert Charles Kelly, Houston, TX (US); Drayon Miller, Mobile, AL (US)

Correspondence Address: Juan C. Villar, Fleit, Kain, Gibbons, Gutman & Bongini, Suite 404, 601 Brickell Key Drive, Miami, FL, 33131, US

(21) Appl. No.: 10/267,066

(22) Filed: Oct. 8, 2002

(51) Int. Cl. B01J 7/00

(52) U.S. Cl. 422/305

(57) ABSTRACT

Disclosed is a gas-release packet, comprising a flexible gas-permeable material enclosing a gas-producing composition that releases gases beneficial to foodstuffs and the like. The packet may be made permeable to water vapor to work with water-activated gas-releasing compositions.

### FIELD OF THE INVENTION

This invention relates to a packet containing a gas-releasing composition that releases gas(es) beneficial to foodstuffs and/or plant life. The packet is permeable to the released gas(es) and so is useful for including in sealed containers for foodstuffs and/or plant life.

### BACKGROUND OF THE INVENTION

It is known in the art to expose biological materials to various chemicals, usually in the gas phase, to preserve them. Chemicals used to provide beneficial results by release of a gas are normally applied by exposure in open containers, which has the disadvantages of accidental spillage and contamination.

There are a number of gases that, when released produce a desirable effect on fresh items such as raw meat, raw fish, produce and flowers. Carbon dioxide, for example, will inhibit mold and bacteria growth and extend the shelf life of all of the aforementioned products.

U.S. Pat. Nos. 4,384,972; 4,411,918; 4,664,922; 4,762,922; 5,489,399 and 6,340,654 disclose methods of generating gases beneficial to foodstuffs, such as carbon dioxide, freshness-retaining agents, and antibacterials, some of which release such beneficial gases upon exposure to moisture.

U.S. Pat. No. 6,194,350, entitled Methods of Blocking Ethylene Response in Plants Using Cyclopropene Derivatives, issued Feb. 27, 2001, to Sisler, E. C., discloses methods of applying C₆₋₂₀ alkyl cyclopropene derivatives and compositions thereof to block ethylene receptors in plants are disclosed. One such method comprises applying to the plant an effective ethylene response-inhibiting amount of cyclopropene derivatives or compositions thereof. Also disclosed are methods of inhibiting abscission in plants and methods of prolonging the life of cut flowers.

U.S. Pat. No. 5,650,446, entitled Sustained Release Biocidal Composition, issued Jul. 22, 1997, to Wellinghoff, et al., discloses a composite for retarding bacterial, fungal, and viral contamination and mold growth that includes a hydrophobic material comprising an acid-releasing agent and a hydrophilic material containing chlorite anions. The hydrophobic and hydrophilic materials are held adjacent and substantially anhydrous. When exposed to moisture, the hydrophilic material releases chlorine dioxide upon hydrolysis of the acid-releasing agent.

Prior art methods of delivery of these technologies has been the use of open containers into which the chemicals are poured, followed by a gas-releasing solvent. This method has the drawback of dispensing too much or too little of either component and is vulnerable to spillage and contamination.

### SUMMARY OF THE INVENTION

Disclosed is sealed gas-permeable flexible packet enclosing a gas-releasing composition, said bag made of a material permeable to a gas released by said gas-releasing composition. The material may be permeable to water vapor for use with gas-releasing compositions that are activated by water if water is not already included in the composition.

In another aspect of the invention, the packet is a pillow style bag.

In another aspect of the invention, the packet is a three-side seal style bag.

In another aspect of the invention, the packet is a four-side seal style bag.

In another aspect of the invention, the packet is a side-gusseted square bottom style bag.

In another aspect of the invention, the packet is a bottom-gusseted stand up style bag.

In another aspect of the invention, said gas-producing chemical is a cyclopropene or derivative thereof.

In another aspect of the invention, said gas-producing chemical produces carbon dioxide gas.

In another aspect of the invention, said gas-producing chemical produces a biocidal gas.

In another aspect of the invention, said gas-producing composition produces a corrosion-inhibiting atmosphere and may include a gas-absorbing composition.

In another aspect of the invention, said gas-permeable material comprises polyethylene homopolymer or copolymer and at least one material selected from the group polyamide, copolyamide, polyester, copolyester, polyethylene copolymer, polypropylene homopolymer or copolymer, polycarbonate, polymethylpentene, polyvinylidene chloride copolymer, polyurethane, polybutylene homopolymer or copolymer, polysulfone, cellulose, polystyrene, and paper.

In another aspect of the invention, said gas-permeable material is permeable to water vapor and comprises at least one of cellulose, polystyrene, or polyurethane.

Disclosed is a gas-release packet, comprising a container the top of which is sealed by a gas-permeable material, and a gas-releasing composition disposed within said container, said gas-permeable material permeable to a gas released by said gas-releasing composition.

In another aspect of the gas-release packet, said gas-permeable material is permeable to water vapor and wherein said gas-releasing composition is activated by water.

In another aspect of the invention, the container is a rigid or semi-rigid cup or tray.

### BRIEF DESCRIPTION OF THE DRAWINGS

FIG. 1 is a top plan view of an embodiment of the invention.

FIG. 2 is a top plan view of another embodiment of the invention.

FIG. 3a is a side-gusseted embodiment of the invention.

FIG. 3b is a bottom-gusseted embodiment of the invention.

FIGS. 4a through 4c show a pillow-style, four-side seal style, and three-side seal style embodiments of the invention respectively.

### DETAILED DESCRIPTION OF THE PREFERRED EMBODIMENTS

The packet of the invention is formed of a gas-permeable material inside of which is packaged a gas-releasing composition. The gas or gases released then passes out through the gas-permeable walls. The packet is for placement within a sealed environment with plants or foodstuffs so as to release beneficial gas(es) therein. Such sealed environments include food packaging for shipment, display cases for meat, foodstuffs, or other biologicals, refrigeration units, storage units, and the like, i.e., essentially any enclosed region within which the atmosphere is substantially sealed from the outside. Water-activated gas-releasing compositions may be packaged with an activating amount of water as part of the composition or, alternatively, the packet may comprise a water vapor-permeable material that permits water vapor from the foodstuffs or plant life to come in contact with the composition therein to activate it.

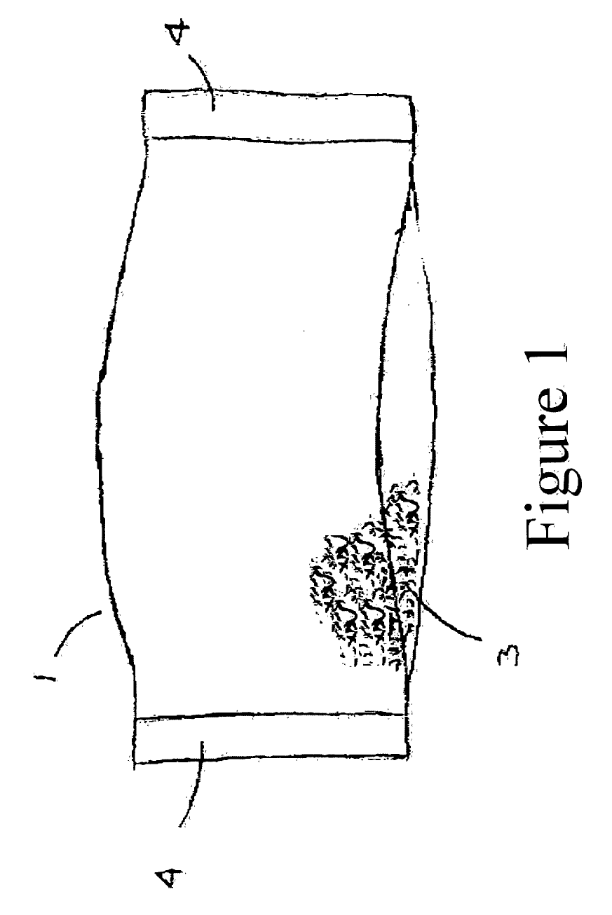

Referring to FIG. 1 there is shown an embodiment of the gas-permeable packet 1 of the invention which contains a gas-releasing composition 3. The gas-releasing composition 3 will generally be a dry chemical or chemicals. The packet may be heat-sealed or adhesively bonded along one or more edges, forming seals 4.

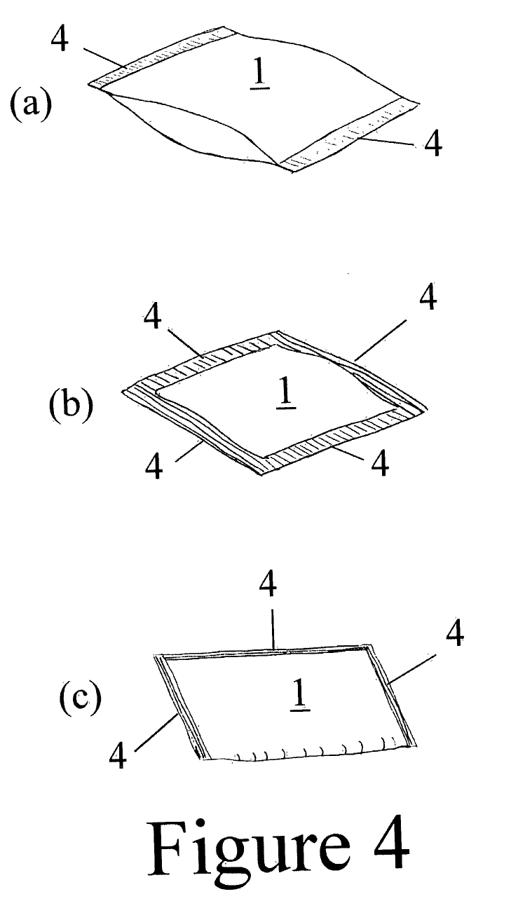

There are a number of convenient ways to manufacture the packet 1. A tube of gas-permeable material may be flattened and sealed at the two open ends, forming the pillow shaped container shown in FIGS. 1 and 4a. Alternatively, a single sheet of gas-permeable material may be folded over and sealed on three sides as shown in FIG. 4c. Alternatively, two sheets of gas-permeable material may be sealed together on four sides as shown in FIG. 4b.

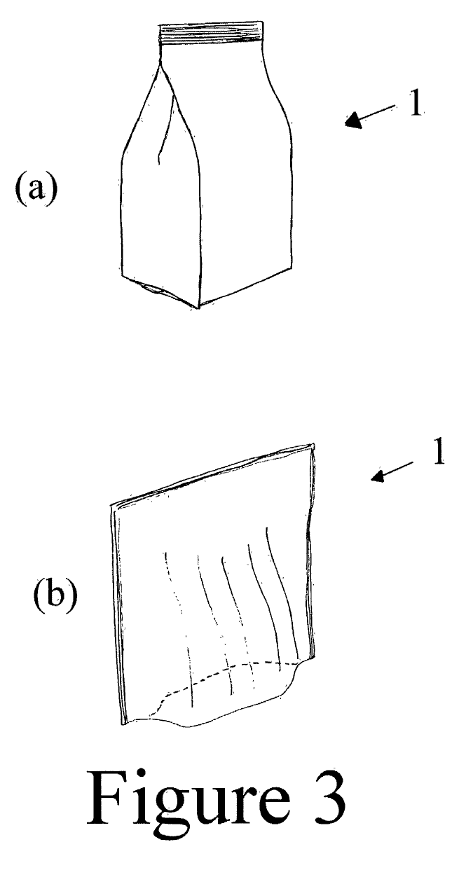

Referring to FIGS. 3a and 3b, the shape of the packet may be side or bottom-gusseted thereby relieving stresses put on the material by the seals and also increasing the surface area of the packet.

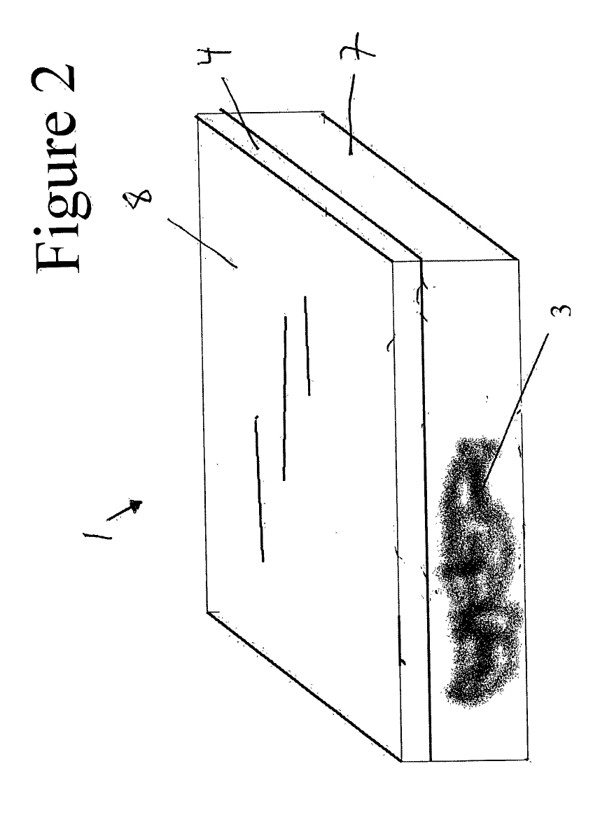

Referring to FIG. 2, in still another embodiment of the invention, a gas-permeable membrane 8 is sealed to a rigid or semi-rigid container 7. The container 7 may be in the nature of a tray, cup or any other suitable configuration.

The materials used for the packet of the invention will present as a solid surface, yet be permeable to gas while impermeable to liquid. Liquid-impermeable gas-permeable materials suited for use with the invention include laminations of polyethylene polymer with one or more other materials. Other materials suited for use as a laminate with polyethylene include polyamides, copolyamides, polyester, copolyesters, polyethylene copolymers, polypropylene homopolymers or copolymers, polycarbonate, polymethylpentene, polyvinylidene chloride copolymer, polyurethane, polybutylene homopolymer or copolymer, polysulfone and paper. Coextrusions of these materials with polyethylene may also be used to create clear or opaque gas-permeable materials.

Specific conditions of use for the gas-permeable packet of the invention determine the suitability of a packet material. Metallocene-modified polyethylene (mLLDPE) is desirable as a sealant layer as its high molecular weight promotes gas transmission. Metallocene-modified polyethylene (mLLDPE) can be used solely as the packet material, but to seal mLLDPE to make a packet it must be heated and then cooled before release from sealing platens. This process is slow and therefore may not be practical for mass production. More desirable is the addition of one or more additional support layers with melting temperatures higher than the sealant layer to support the sealant layer when it is in the molten state. Paper is a desirable outer layer as it has high gas and water vapor transmission rates and provides stiffness to the packet material. Polyethylenes including low density (LDPE), linear low density (LLDPE), and mLLDPE cannot be used where outside moisture is required to activate the gas release process because polyethylenes have low water vapor transmission rates (WVTR).

Other suitable support layers are cellulose, polystyrene and polyurethane due to their high gas transmission rates.

A packet of the invention containing a substance that requires water vapor transmission through the packet for activation of its gas release would best be made of cellulose, polystyrene, or polyurethane due to their high WVTR and gas transmission rates. Polystyrene and polyurethane both present sealing problems and are best coated with an adhesive to allow sealing. As the adhesive diminishes transmission rates the adhesive should be applied only in the seal areas 4.

As indicated, the gas-releasing compositions may be any such chemical compositions suitable to the purpose, such as cyclopropenes and their derivatives as are disclosed in Daly, et al., U.S. Pat. No. 6,017,849; chlorine dioxide releasing compositions, such as disclosed in Wellinghoff et al., U.S. Pat. No. 5,650,466; C₆₋₂₀ alkyl cyclopropene derivatives, such as are described in Sisler, U.S. Pat. No. 6,194,350; the disclosures of all of which are incorporated by reference herein in their entirety. A commercially available cyclopropene derivative is 1-methylcyclopropene, sold under the tradename EthylBloc by Rohm & Haas.

Also suitable as gas-releasing compositions are salts of manganese (II), iron (II), cobalt (II), or nickel (II) combined with an alkali and sulfite or a deliquescent substance and optionally ascorbic acid or its salt, which absorb oxygen and/or release carbon dioxide, thereby also effecting a corrosion-inhibiting atmosphere in addition to being beneficial to foodstuffs, such as is disclosed in Nakamura et al., U.S. Pat. No. 4,384,972; carbon dioxide releasing compositions such as disclosed in Leon et al., U.S. Pat. No. 4,664,922; antibacterial releasing compositions such as are disclosed in Breuer et al., U.S. Pat. No. 4,762,922; carbon dioxide generating compositions such as are described in Koyakumaru et al., U.S. Pat. No. 5,489,399; and compositions of organic acid and hydrogencarbonates such as are disclosed in lijima, U.S. Pat. No. 6,340,654; the disclosures of all of which are incorporated by reference herein in their entirety.

Also useful are other water-activated carbon dioxide-releasing compositions such as sodium bicarbonate, acetylsalicylic acid, and mixtures thereof, known to benefit live plants and prolong shelf life of many perishables, such as is described in Fuller, P. E., Published U.S. patent application Ser. No. 09/771,334, entitled Treatment of Perishable Products Using Aqueous Chemical Composition, filed Jan. 26, 2001, the disclosures of which are incorporated by reference herein in their entirety. Also known are compositions that release both carbon dioxide and sulfur dioxide, a gas mixture useful for preserving grapes, such as citric or tartaric acid, sodium bicarbonate, and sodium or potassium bisulphate as described in Cimino et al., U.S. Pat. No. 4,411,918, the disclosures of which are incorporated by reference herein in their entirety.

Note that gas-absorbing compositions may also be used such as to offer control of the environment in which the packet is placed. For example, such a packet could be placed in metal containers as a means of inhibiting corrosion. This may be achieved by placing in the packet a composition that releases a corrosion inhibiting gas and another composition that absorbs water vapor and/or oxygen, thereby removing the corroding water vapor from the container, such as by combining the composition of Nakamura, supra, with a desiccant. Should the gas-releasing and gas-absorbing compositions be incompatible, the packet may be divided into compartments with, for example, a heat seal, so as to separate the compositions. Alternatively, each composition may be individually sealed in its own packet and the user need only place one of each type into the container.

While various values, scalar and otherwise, may be disclosed herein, it is to be understood that these are not exact values, but rather to be interpreted as “about” such values, Further, the use of a modifier such as “about” or “approximately” in this specification with respect to any value is not to imply that the absence of such a modifier with respect to another value indicates the latter to be exact.

Changes and modifications can be made by those skilled in the art to the embodiments as disclosed herein and such examples, illustrations, and theories are for explanatory purposes and are not intended to limit the scope of the claims.

What is claimed is:

1. A sealed liquid-impermeable gas-permeable flexible packet enclosing a gas-releasing composition, said bag made of a material permeable to a gas released by said gas-releasing composition.

2. The packet of claim 1 wherein the packet style is selected from a pillow style bag, a side-gusseted square-bottom style bag, or a bottom-gusseted stand-up style bag.

3. The packet of claim 1 wherein the packet style is selected from a three-side seal style bag or a four-side seal style bag.

4. The packet of claim 1 wherein said gas-producing chemical is a cyclopropene or derivative thereof.

5. The packet of claim 1 wherein said gas-producing chemical produces carbon dioxide gas.

6. The packet of claim 1 wherein said gas-producing chemical produces a biocidal gas.

7. The packet of claim 1 wherein said liquid-impermeable gas-permeable material comprises:
polyethylene homopolymer or copolymer; and
at least one material selected from the group polyamide, copolyamide, polyester, copolyester, polyethylene copolymer, polypropylene homopolymer or copolymer, polycarbonate, polymethylpentene, polyvinylidene chloride copolymer, polyurethane, polybutylene homopolymer or copolymer, polysulfone, cellulose, polystyrene, and paper.

8. The packet of claim 1 wherein said gas-releasing composition further comprises a gas-absorbing component, said composition effective in inducting a corrosion-inhibiting atmosphere in a closed environment in which the packet is placed.

9. A sealed liquid-impermeable gas-permeable flexible packet enclosing a water-activated gas-releasing composition, said bag made of a material permeable to water vapor and a gas released by said gas-releasing composition.

10. The packet of claim 1 wherein the packet style is selected from a pillow style bag, a side-gusseted square-bottom style bag, or a bottom-gusseted stand-up style bag.

11. The packet of claim 1 wherein the packet style is selected from a three-side seal style bag or a four-side seal style bag.

12. The packet of claim 9 wherein said gas-producing chemical is a cyclopropene or derivative thereof.

13. The packet of claim 9 wherein said gas-producing chemical produces carbon dioxide gas.

14. The packet of claim 9 wherein said gas-producing chemical produces a biocidal gas.

15. The packet of claim 9 wherein said liquid-impermeable gas-permeable material comprises at least one of cellulose, polystyrene, or polyurethane.

16. The packet of claim 9 wherein said gas-releasing composition further comprises a gas-absorbing component, said composition effective in inducting a corrosion-inhibiting atmosphere in a closed environment in which the packet is placed.

17. A gas-release packet, comprising:
a container the top of which is sealed by a liquid-impermeable gas-permeable material;
a gas-releasing composition disposed within said container, said liquid-impermeable gas-permeable material permeable to a gas released by said gas-releasing composition.

18. The packet of claim 17 wherein said liquid-impermeable gas-permeable material is permeable to water vapor and wherein said gas-releasing composition is activated by water.

19. The packet of claim 17 wherein said gas-releasing composition further comprises a gas-absorbing component, said composition effective in inducting a corrosion-inhibiting atmosphere in a closed environment in which the packet is placed.

20. The packet of claim 17 wherein said container is a rigid cup or tray.

21. The packet of claim 17 wherein said container is a semi-rigid cup or tray.
